(19) United States
(12) Patent Application Publication
(10) Pub. No.: US 2009/0058655 A1
(43) Pub. Date: Mar. 5, 2009

(54) Method and Apparatus for Monitoring a Drum with an RFID Tag

(75) Inventor: John Peter Norair, Palo Alto, CA (US)

Correspondence Address: HAYNES AND BOONE, LLP;IP Section, 2323 Victory Avenue, Suite 700, Dallas, TX, 75219, US

(73) Assignee: Savi Technology, Inc., Mountain View, CA (US)

(21) Appl. No.: 12/167,957

(22) Filed: Jul. 3, 2008

Related U.S. Application Data
(60) Provisional application No. 60/948,105, filed on Jul. 5, 2007.

(51) Int. Cl. G08B 13/14

(52) U.S. Cl. 340/572.1

(57) ABSTRACT

A drum has a body, a lid, and fastening structure cooperable with portions of the body and lid to effect a releasable coupling therebetween. A sensor is disposed between the two portions. According to a different aspect, a support member has a flange with a hole, and a pressure sensor on the flange. A tag on the support member has circuitry responsive to the sensor for transmitting wireless signals. According to yet another aspect, a drum has a body, a lid, and fastening structure to effect a releasable coupling between the lid and the body. A method involves monitoring with a pressure sensor a force produced by the fastening structure.

This application claims the priority under 35 U.S.C. §119 of provisional application No. 60/948,105 filed Jul. 5, 2007, the disclosure of which is hereby incorporated herein by reference.

### FIELD OF THE INVENTION

This invention relates in general to techniques for monitoring containers and, more particularly, to techniques for monitoring storage drums.

### BACKGROUND

Nuclear material and other hazardous materials are sometimes stored in drums, where the storage drum includes a body with a chamber, and a lid secured to the body by a plurality of bolts. There is a need for automated monitoring of inventories of these storage drums, including tracking of the location and movement of the drums. Moreover, in view of the nature of the materials frequently stored within such drums, there is a need for automated detection of an attempt to open or otherwise tamper with a drum, and the monitoring itself must also be resistant to tampering.

### BRIEF DESCRIPTION OF THE DRAWINGS

A better understanding of the present invention will be realized from the detailed description that follows, taken in conjunction with the accompanying drawings, in which:

FIG. 1 is diagrammatic fragmentary perspective view of an apparatus that embodies aspects of the invention, and that includes a storage drum and a tag assembly supported on the drum.

FIG. 2 is a diagrammatic fragmentary perspective view that shows, in an enlarged scale, a portion of the apparatus of FIG. 1.

FIG. 3 is a diagrammatic sectional side view of a pressure sensor that is a component of the apparatus of FIGS. 1 and 2.

FIG. 4 is a circuit schematic showing the pressure sensor of FIG. 3 as a variable capacitor, and showing a selected portion of circuitry within a tag that is a component of the tag assembly in FIG. 1.

FIG. 5 is a circuit schematic similar to FIG. 4, but in which the circuitry within the tag also includes an inductor.

FIG. 6 is a timing diagram, depicting an input pulse and showing how the circuits of FIGS. 4 and 5 would each respond to this pulse.

FIG. 7 is a diagrammatic sectional side view of a pressure sensor that is an alternative embodiment of, and can be substituted for, the pressure sensor of FIG. 3.

FIG. 8 is a circuit schematic of an equivalent circuit associated with the pressure sensor of FIG. 7.

FIG. 9 is a diagrammatic fragmentary perspective view of an apparatus that is an alternative embodiment of the apparatus of FIG. 1.

FIG. 10 is a diagrammatic fragmentary perspective view of an apparatus that is an alternative embodiment of the apparatus of FIG. 9.

FIG. 11 is a circuit schematic showing a resistive pressure sensor that can be substituted for either of the capacitive pressure sensors of FIGS. 3 and 7, and showing a selected portion of circuitry within a tag.

FIG. 12 is a circuit schematic showing the pressure sensor of FIG. 10 with a different arrangement of circuitry within a tag.

### DETAILED DESCRIPTION

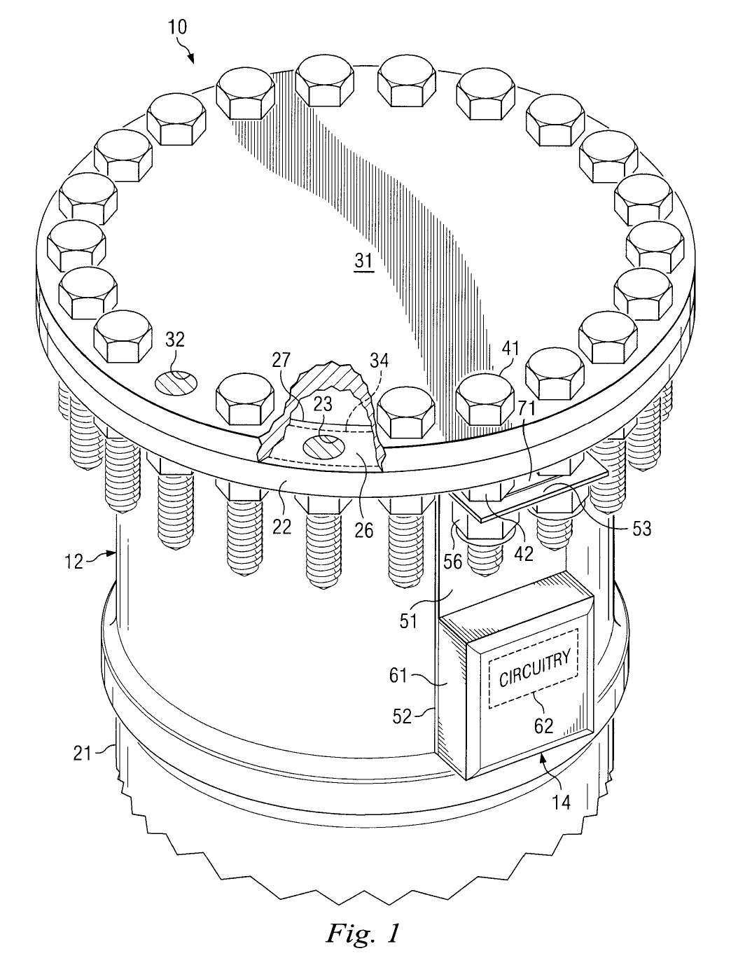

FIG. 1 is diagrammatic fragmentary perspective view of an apparatus 10 that embodies aspects of the invention. The apparatus 10 includes an approximately cylindrical storage drum 12, and a radio frequency identification (RFID) tag assembly 14 that is mounted on the drum. In the embodiment of FIG. 1, the drum 12 is a conventional and commercially available product, and is therefore described here only briefly, to an extent that will facilitate an understanding of the present invention. One common use for the drum 12 is the storage of hazardous material, and one example of hazardous material is nuclear material.

The drum 12 is made from stainless steel, but could alternatively be made of one or more other suitable materials. The drum 12 includes an approximately cylindrical body 21, and the body has at an upper end a radially outwardly projecting portion that defines an annular flange 22. The flange 22 has a plurality of circumferentially spaced holes 23 extending vertically therethrough. The body 21 has a top surface 26 on the upper side of the annular flange 22. A cylindrical chamber 27 opens downwardly into the body 21 from a circular opening through the top surface 26. The chamber 27 holds the hazardous material or other material that is being stored within the drum 12.

The drum 12 further includes a lid 31 in the form of a circular disc. The diameter of the disc is substantially the same as the outside diameter of the annular flange 22. The disc has a plurality of circumferentially spaced holes 32 extending vertically therethrough, in an outer peripheral edge portion thereof. Each of the holes 32 is aligned with a respective one of the holes 23 in the flange 22. An annular gasket 34 is provided between the flange 22 and the lid 31, as indicated diagrammatically by broken lines in FIG. 1. The gasket 34 has a plurality of circumferentially spaced holes that are each aligned with a respective pair of the holes 23 and 32.

The drum 12 also includes a fastening arrangement for releasably and sealingly coupling the lid 31 to the body 21. The fastening arrangement includes a plurality of fastening bolts 41, and a plurality of fastening nuts 42. Each of the fastening bolts 41 has a head and a threaded shank, the threaded shank extending through a respective pair of the aligned openings 23 and 32, with the head engaging the top surface of the lid 31. Each bolt 41 has a respective fastening nut 42 on the threaded shank thereof, with the nut engaging the underside of the annular flange 22.

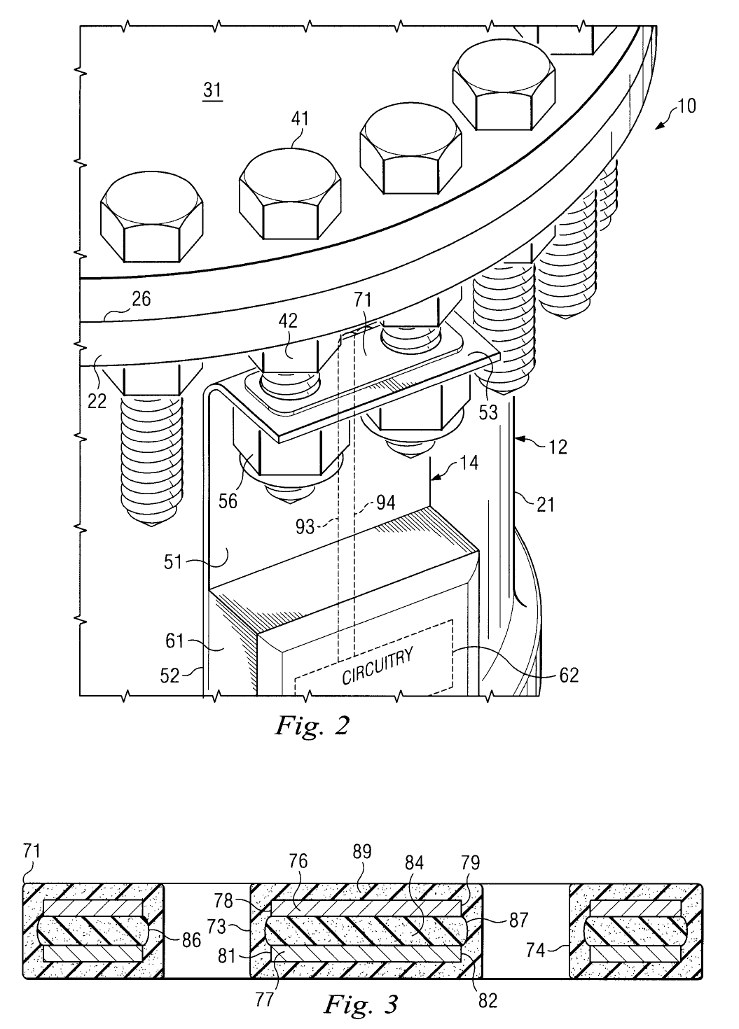

FIG. 2 is a diagrammatic fragmentary perspective view that shows, in an enlarged scale, a portion of the apparatus 10 of FIG. 1. With reference to FIGS. 1 and 2, the tag assembly 14 includes a support member 51 in the form of a metal plate having two portions 52 and 53. The plate 51 has a 90° bend between the portions 52 and 53, so that the portions 52 and 53 extend at a right angle with respect to each other. The portion 52 extends vertically and is disposed adjacent a cylindrical exterior surface of the body 21 of the drum 12. The portion 53 is a flange that extends horizontally outwardly from an upper end of the vertical portion 52. The flange 53 has two spaced holes extending vertically therethrough, and each hole receives the threaded shank of a respective one of the bolts 41. The tag assembly 14 includes two additional nuts 56, and each of the nuts 56 engages a respective one of the two threaded bolt shanks that extend through the holes in the flange 53. The flange 53 is thus disposed between the two nuts 56, and two of the nuts 42.

An RFID tag 61 is fixedly secured to the lower end of the vertical portion 52 of the support member 51. The tag 61 includes electrical circuitry, which is indicated diagrammatically by a broken line 62 in FIG. 1. The circuitry 62 is not illustrated in detail, but includes a microprocessor-based control circuit, a radio frequency (RF) transceiver, and an antenna. The circuitry 62 is capable of transmitting wireless signals to a remote and not-illustrated device, for example a device of the type commonly known as a reader.

With reference to FIG. 2, a platelike pressure sensor 71 is supported on the top surface of the flange 53 of the support member 51. FIG. 3 is a diagrammatic sectional side view of the pressure sensor 71. For clarity, the thickness of the pressure sensor 71 is greatly exaggerated in FIG. 3. The pressure sensor 71 is fabricated using thin film technology, and therefore has a relatively small thickness.

With reference to FIG. 3, the pressure sensor 71 has two spaced holes 73 and 74 that extend vertically therethrough, and these holes are each aligned with a respective one of the holes through the flange 53 of the support member 51. The threaded shank of a respective bolt 41 extends through each of the holes 73 and 74. The pressure sensor 71 has two vertically spaced, platelike layers 76 and 77 that are each made from metal or some other electrically conductive material. The layer 76 has two spaced holes 78 and 79 that extend vertically therethrough. The holes 78 and 79 are larger than and concentrically aligned with the holes 73 and 74 through the sensor 71. Similarly, the layer 77 has two spaced holes 81 and 82 that extend vertically therethrough. The holes 81 and 82 are larger than and concentrically aligned with the holes 73 and 74 through the sensor 71.

A layer 84 of electrically insulating material is provided between the conductive layers 76 and 77. The insulating layer 84 has a pair of spaced holes 86 and 87 that are larger than and concentrically aligned with the holes 73 and 74 through the sensor 71. The layers 76, 77 and 84 are all embedded within an outer coating 89 that is made of an electrically insulating material, and that has the holes 73 and 74 extending therethrough. The insulating layer 84 and the outer coating 89 are each made from a material that is somewhat compressible, such as a polyester film. In FIG. 3, the layer 84 is shown as being separate from the outer coating 89, but it would alternatively be possible to combine the layer 84 and the coating 89, so that they are respective portions of a single integral piece of material that is compressible and electrically insulating.

In FIG. 2, the nuts 56 have each been unscrewed a couple of turns from their normal operational position, in order to provide a better view of the flange 53 and the pressure sensor 71. But for normal operation, the nuts 56 would tightened, as shown in FIG. 1, so that the nuts 42 and the flange 53 exert compressive forces on at least the end portions of the pressure sensor 71. The nuts 42 may be tightened against the annular flange 22 more snugly than the two nuts 56 are tightened against the flange 53. In any event, and with reference to FIG. 3, the compressive forces exerted on the pressure sensor 71 will effect some compression of both the insulating layer 84 and the outer coating 89. And to the extent the insulating layer 84 is compressed, the conductive layers 76 and 77 move vertically closer to each other. This is in turn changes the capacitance that exists between the two spaced conductive layers 76 and 77. Thus, the pressure sensor 71 is, in effective, a form of variable capacitor.

With reference to FIG. 2, two wires are shown diagrammatically at 93 and 94. Each of these wires has its upper end electrically coupled to a respective one of the conductive layers 76 and 77 (FIG. 3) in the pressure sensor 71. The wires 93 and 94 extend inwardly from the pressure sensor 71 toward the drum body 21, and then extend downwardly behind the vertical portion 52 of the support member 51. At their lower ends, the wires 93 and 94 are each coupled to the circuitry 62 within the tag 61. If someone attempts to open the drum 12, and thus loosens and/or removes the nuts 56, the compressive forces that are normally exerted on the pressure sensor 71 will be reduced or eliminated, and the natural resilience of the insulating layer 84 will move the conductive layers 76 and 77 away from each other to their normal positions, thereby changing the capacitance that exists between the two conductive layers 76 and 77. Since the capacitance varies non linearly as the square of the distance between the two conductive layers 76 and 77, a small change in spacing can produce a readily detectible difference in capacitance.

The circuitry 62 within the tag 61 can detect a change in capacitance through the wires 93 and 94, and can then transmit a wireless signal that contains information indicating the pressure sensor 71 detected a condition that may have been caused by tampering with the storage drum 12. With reference to FIG. 1, the pressure sensor 71 is positioned so that access to it is physically difficult, thereby making it difficult for a person to access the pressure sensor 71 and attempt to defeat it. Further, the pressure sensor 71 is configured to have a relatively small capacitance so that, if a person attempting to defeat the pressure sensor electrically connects any sort of additional component to the sensor, such as a signal generator, a switch or a probe, the additional component will, in and of itself, add enough additional capacitance to cause the tag 61 to detect a problem and transmit a wireless alarm signal.

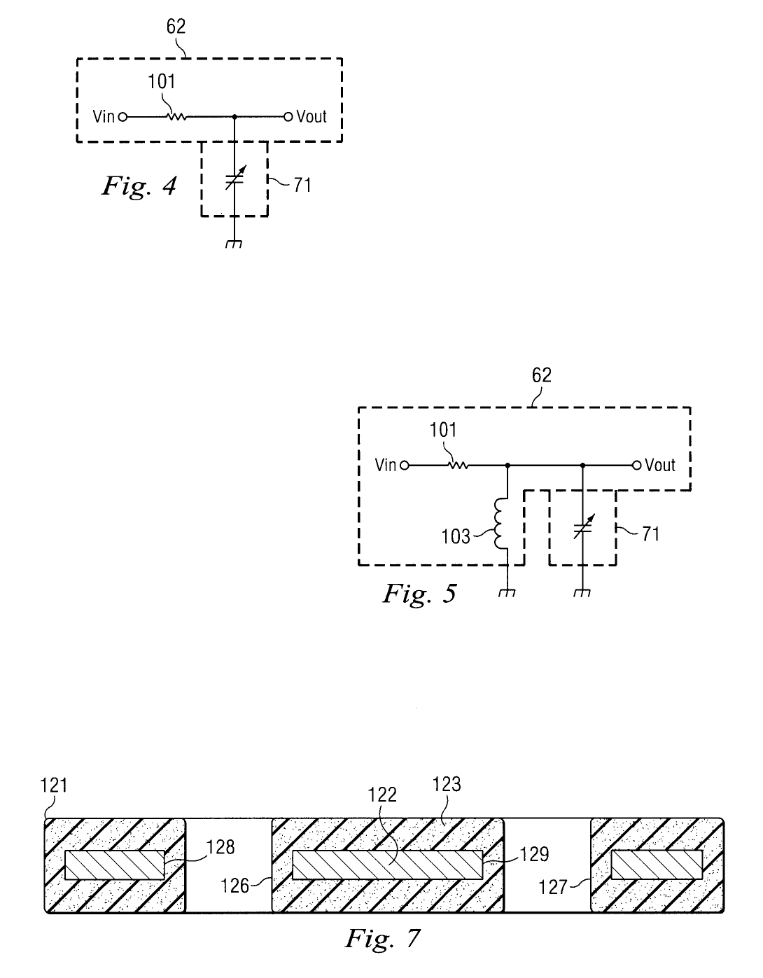

The capacitance of the pressure sensor 71 varies nonlinearly in response to a change in pressure, and this nonlinear variation also helps to resist tampering. For example, FIG. 4 is a circuit schematic showing the pressure sensor 71 as a variable capacitor, and showing a selected portion of the circuitry 62 within the tag 61. The circuitry includes a resistor 101 that is coupled in series with the pressure sensor 71.

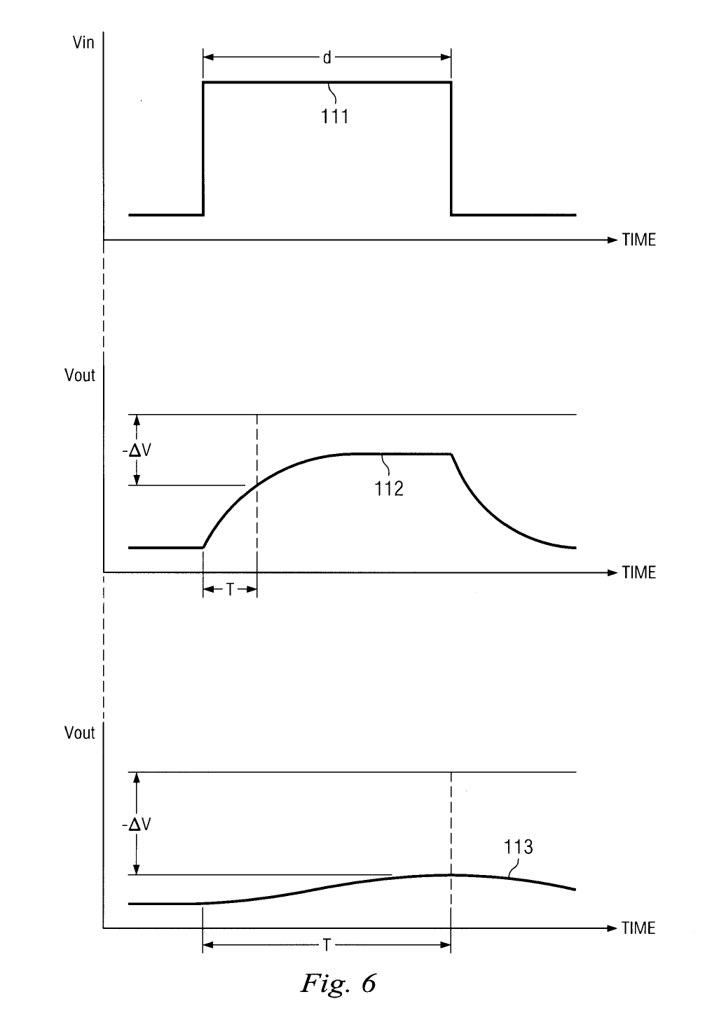

The nonlinearity of the capacitance can be enhanced by providing at least one additional nonlinear component within the circuitry 62. For example, FIG. 5 is a circuit schematic in which the circuitry 62 within the tag includes not only the resistor 101, but also an inductor 103 that is coupled in parallel with the capacitive pressure sensor 71. FIG. 6 is a timing diagram, where signal 111 is an input pulse supplied to the input terminal Vin in either FIG. 4 or FIG. 5. In FIG. 6, the signal 112 is the signal that would result at the output terminal Vout in FIG. 4, and the signal 113 is the signal that would result at the output terminal Vout in FIG. 5. As to FIG. 5, since the resistor 101, inductor 103 and capacitive pressure sensor 71 form a resonant RLC circuit, the pulse 111 would be one pulse from a train of pulses at the resonant frequency of the RLC circuit.

It will be noted that the output signal 113 is a significantly attenuated version of the input pulse 111, and exhibits high sensitivity when sampled at any point. The RLC circuit of FIG. 5 offers an excellent mix of low cost and tamper resistance, because an inexpensive inductor with a relatively large inductance can be paired with a pressure sensor 71 having a relatively small capacitance, in order to achieve modest resonant frequencies that can be synthesized with a cheap, low-power microcontroller that is provided within the circuitry 62 of the tag. It is possible that the capacitance of the pressure sensor 71 might change or “creep” over time, even without any tampering. But the microcontroller within the circuitry 62 can easily detect and compensate for this gradual creep.

FIG. 7 is a diagrammatic sectional side view of a pressure sensor 121 that is an alternative embodiment of, and can be substituted for, the pressure sensor 71 of FIG. 3. The pressure sensor 121 includes a single electrically-conductive layer 122 that is embedded within a single layer 123 of insulating material, where the insulating layer 123 is at least slightly compressible. The layer 123 has two spaced openings 126 and 127 therethrough that can receive the threaded shanks of two of the bolts 41 (FIG. 1). The conductive layer 122 has two openings 128 and 129 therethrough, which are larger than and respectively aligned with the two openings 126 and 127.

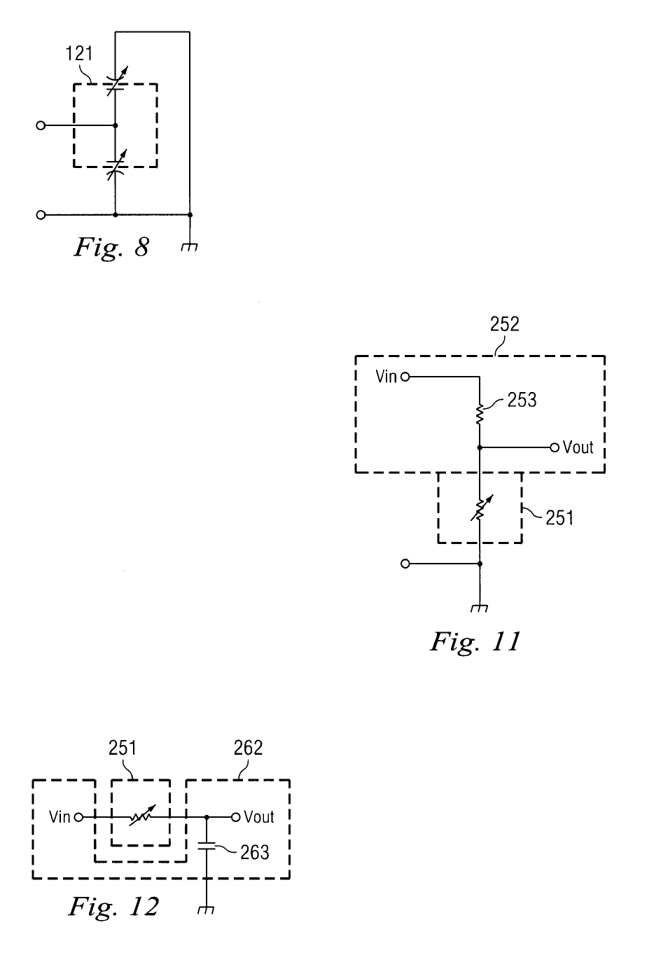

The pressure sensor 121 is effectively a capacitor. The conductive layer 122 forms one plate of the capacitor. The other plate of the capacitor is defined by metallic structure that is external to and adjacent the pressure sensor 21, including the flange 53 of the support member 51, the nuts 42 and 56, and the threaded shanks of the bolts 41. The support member 51 and the drum 12 effectively define a common ground, where the drum 21, lid 31, bolts 41, nuts 42, nuts 56 and support member 51 are all electrically coupled to each other. Although the embodiment of FIG. 2 has two wires 93 and 94 that run from the sensor 71 to the circuitry 62 in the tag 61, in the case of the sensor 121 of FIG. 7, only a single wire would run from the conductive layer 122 to the circuitry 62 in the tag 61. Instead of a second wire, the circuitry 62 in the tag 61 would include a direct electrical connection to the support member 51. FIG. 8 is a circuit schematic of an equivalent circuit associated with the pressure sensor 121.

FIG. 9 is a diagrammatic fragmentary perspective view of an apparatus 151 that is an alternative embodiment of the apparatus 10 of FIG. 1. The apparatus 151 of FIG. 9 is generally identical to the apparatus 10 of FIG. 1, except for differences that are discussed below. Identical or equivalent parts are identified with the same reference numerals in FIG. 9.

The apparatus 151 includes a drum 156 with a body 157. The body 157 is generally similar to the drum body shown at 21 in FIG. 1, except that the body 157 has a shallow recess 162 provided in a cylindrical external surface 161 of the body. A short passageway 164 extends radially from the recess 162 to the chamber 27 (FIG. 1) within the body 157. The embodiment of FIG. 1 includes the support member 51 and the nuts 56, but these components are omitted from the apparatus 151 of FIG. 9. Instead, the pressure sensor 71 is disposed between the peripheral edge of lid 31 and the annular flange 22 of body 157. The wires 93 and 94 extend inwardly from the sensor 71, and then extend downwardly within the chamber in the drum 156 to the passageway 164, and then extend radially outwardly through the passageway 164 to a tag 176 disposed within the recess 162. A plug or a sealant is provided within the passageway 164, in order to prevent liquid material stored within the drum from leaking out through the passageway.

The circuitry within the tag 176 is equivalent to the circuitry 62 within the tag 61 of FIG. 1. However, the tag 176 has a housing with an exterior shape that is different from the exterior shape of the tag 61 of FIG. 1. In particular, the tag 176 in FIG. 9 has an inner surface that conforms to the shape of the recess 62, and has an outwardly-facing exterior surface 178 that is a portion of a cylindrical surface. In particular, the surface 178 is flush with and conforms in shape to the cylindrical exterior surface 161 on the body 157. The tag 176 is removably held in the recess 162 by four screws 179 that extend through openings in the tag 176, and that engage threaded blind holes provided in the body 157 of the drum 156. The side wall of the body 157 may have, in the region of the recess 162, a not-illustrated inward bulge on an inner side thereof, in order to accommodate the recess 162 while maintaining the strength of the wall.

FIG. 10 is a diagrammatic fragmentary perspective view of an apparatus 210 that is an alternative embodiment of the apparatus 151 of FIG. 9. Identical or equivalent parts are identified with the same reference numerals. The apparatus 210 of FIG. 10 is generally identical to the apparatus 151 of FIG. 9, except for certain differences that are discussed below.

A fundamental difference between FIGS. 9 and 10 is that the tag 176 of FIG. 9 is omitted in FIG. 10. Instead, in FIG. 10, the recess 162 is filled with a material 216, which conforms to the shape of the recess, and which has an exterior surface 217 that is a portion of a cylindrical surface. In particular, the exterior surface 217 is flush with and conforms in shape to the cylindrical exterior surface 161 on the body 157 of the drum 156. The material 216 in the recess 162 may, for example, be a commercially available epoxy adhesive. A tag 221 is embedded within the material 216. The tag 221 includes circuitry that is coupled to the wires 93 and 94, and that is equivalent to the circuitry 62 in the tag 61 of FIG. 1.

The embodiments of FIGS. 9 and 10 use different techniques for embedding an RFID tag into the wall of a storage drum. A benefit of these embedded tags is that they each reduce the exposure of the tag to physical damage during handling of the storage drum. For example, when equipment such as a crane or forklift is being used to move drums, or is operating near drums, it is difficult for the equipment to inadvertently hit and damage the embedded tags.

The embodiments discussed above each use a pressure sensor 71 or 121 that is effectively a variable capacitor. However, it would alternatively be possible to use a similar thin film device that is a variable resistor rather than a variable capacitor. In other words, the resistance of the sensor would vary in response to changes in compressive forces exerted on the sensor. Capacitive pressure sensors such as those shown at 71 and 121 have capacitances that vary nonlinearly in response to variation of an applied pressure. In contrast, in the case of a pressure sensor with a variable resistance, the resistance will tend to vary approximately linearly in response to variation of an applied pressure.

In this regard, FIG. 11 is a circuit schematic showing a resistive pressure sensor 251 that can be substituted for either of the capacitive pressure sensors 71 and 121. The resistance of the pressure sensor 251 varies linearly in response to variation of an applied pressure. The circuitry 252 within an associated tag includes a resistor 253 that is coupled in series with the resistance of the pressure sensor 251. The circuit of FIG. 11 will have a generally linear response. Thus, for example, if the input pulse shown at 111 in FIG. 6 is applied at the terminal Vin in FIG. 11, the resulting signal at the output terminal Vout will be similar in shape to the input pulse 111, but will have a different amplitude.

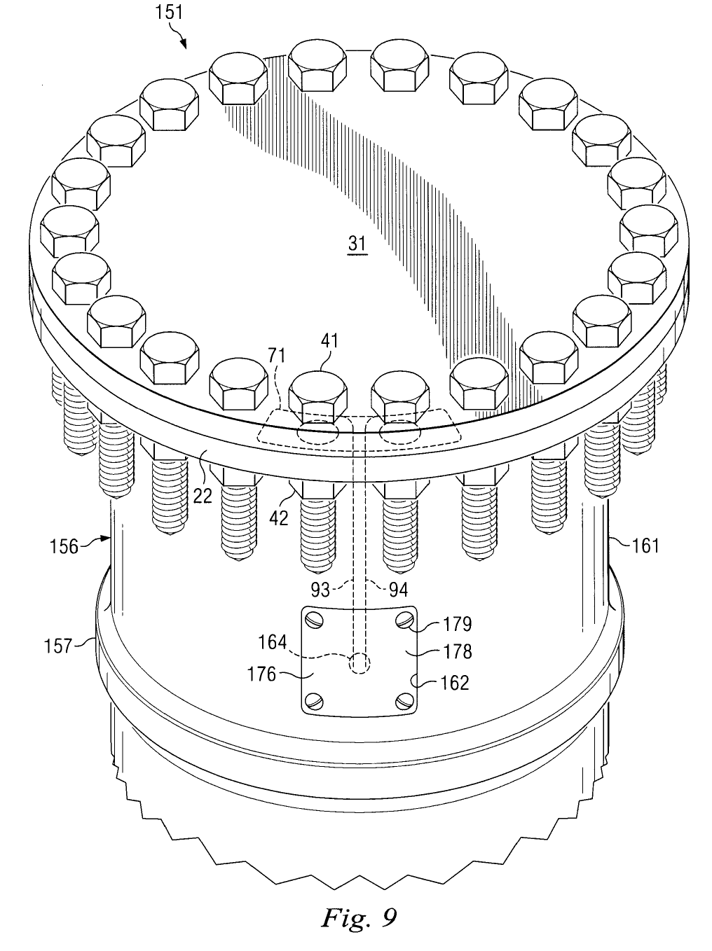

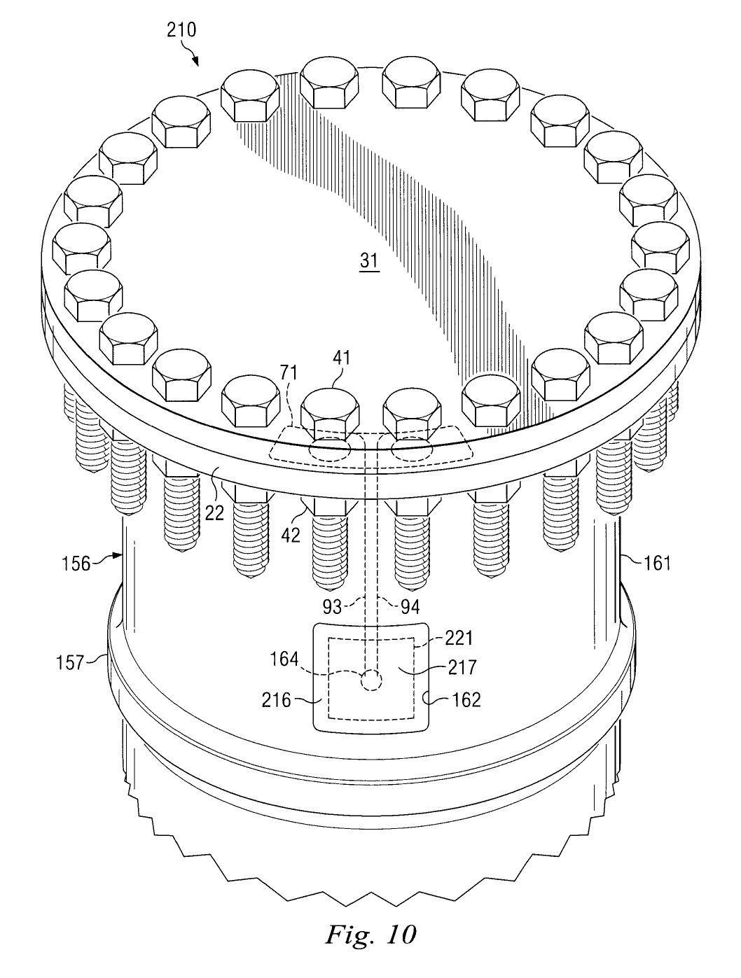

FIG. 12 is a circuit schematic showing the pressure sensor 251 with a different arrangement of circuitry 262 within the associated tag, where the circuitry 262 includes a capacitor 263 coupled to the resistive pressure sensor 251. If the input signal shown at 111 in FIG. 6 is applied to the terminal Vin in FIG. 12, the resulting signal at the output terminal Vout in FIG. 12 will be similar to the signal shown at 112 in FIG. 6.

The foregoing discussion explains how the circuitry within the disclosed RFID tags can transmit a wireless signal in response to a signal from a pressure sensor. In addition, the tag circuitry can transmit wireless signals that help track the physical location of the tag and the associated storage drum. For example, the circuitry in the tag can receive localized wireless signals from stationary signposts that the tag passes, and then transmit wireless signals containing an identification code for the tag and also an identification code from a recently-received signpost signal. The tag's identification code uniquely identifies the tag, and the identification code from the signpost uniquely identifies the signpost. The physical location of the signpost is known, and in order to have received a signal from that signpost, the tag must be physically near that signpost. The identification code for the tag indicates which particular tag is near that signpost.

Although selected embodiments have been illustrated and described in detail, it should be understood that a variety of substitutions and alterations are possible without departing from the spirit and scope of the present invention, as defined by the claims that follow.

What is claimed is:

1. An apparatus comprising:
a drum having a body, a lid, and fastening structure for effecting a releasable coupling between said lid and said body, said body having a chamber therein, having an exterior surface with an opening therein that communicates with said chamber, and having a first portion, said lid being removably disposed adjacent said body so as to obstruct said opening, and having a second portion disposed adjacent said first portion, said fastening structure being cooperable with said first and second portions; and
a sensor disposed between said first and second portions.

2. An apparatus according to claim 1,
wherein said first and second portions each have a hole therethrough, said holes being aligned; and
wherein said fastening structure includes a fastening part that extends through said aligned holes in said first and second portions.

3. An apparatus according to claim 2, wherein said fastening part includes a bolt having a head and a threaded shank, and includes a nut engaging said shank, said shank extending through said aligned holes in said first and second portions, with said first and second portions disposed between said head and said nut.

4. An apparatus according to claim 2, wherein said sensor has a hole therethrough that is aligned with said holes through said first and second portions, said fastening part extending through said hole in said sensor.

5. An apparatus according to claim 4,
wherein said first portion has a further hole therethrough, said holes through said first portion being spaced;
wherein said second portion has a further hole therethrough that is aligned with said further hole through said first portion;
wherein said sensor has a further hole therethrough that is aligned with said further holes through said first and second portions; and
wherein said fastening structure includes a further fastening part that extends through said further openings in said sensor, said first portion and said second portion.

6. An apparatus according to claim 1, wherein said sensor is a thin-film component.

7. An apparatus according to claim 1, wherein said sensor is a pressure sensor having a resistance that varies as a function of pressure applied to said sensor by said first and second portions.

8. An apparatus according to claim 1, wherein said sensor is a pressure sensor having a capacitance that varies as a function of pressure applied to said sensor by said first and second portions.

9. An apparatus according to claim 8, wherein said pressure sensor has spaced first and second parts that are electrically conductive, and has a layer that is disposed between said first and second parts, that is made of a compressible material, and that is electrically insulating.

10. An apparatus according to claim 8, wherein said pressure sensor has an electrically conductive part, and has on at least one side of said electrically conductive part a layer that is made of a compressible material, and that is electrically insulating.

11. An apparatus according to claim 8, wherein said capacitance varies nonlinearly in response to applied pressure.

12. An apparatus according to claim 11, including circuitry that is electrically coupled to said pressure sensor, and that increases the nonlinearity with which said capacitance varies in response to applied pressure.

13. An apparatus according to claim 1, including a tag supported on said drum, said tag including circuitry that is electrically coupled to said sensor, and that can transmit wireless signals.

14. An apparatus according to claim 13, wherein said body has a further exterior surface with a recess therein, said tag being disposed within said recess.

15. An apparatus according to claim 14, wherein said tag has thereon an exterior surface that is flush with and conforms in shape to a shape of said further exterior surface of said body.

16. An apparatus according to claim 14, including a material disposed within said recess and having an exterior surface that is flush with and conforms in shape to a shape of said further exterior surface of said body, said tag being maintained in said recess by said material.

17. An apparatus according to claim 14,
wherein said body has a passageway extending from said recess to said chamber; and
including wires that extend from said tag to said sensor through said passageway and said chamber.

18. An apparatus comprising:
a support member having a flange, said flange having a hole therethrough;
a pressure sensor supported on said flange; and
a tag supported on said support member at a location spaced from said flange, said tag having a circuit that can transmit wireless signals, and said circuit being electrically coupled to said pressure sensor.

19. An apparatus according to claim 18, wherein said pressure sensor is a thin-film component.

20. An apparatus according to claim 18, wherein said pressure sensor has a resistance that varies as a function of applied pressure.

21. An apparatus according to claim 18, wherein said pressure sensor has a capacitance that varies as a function of applied pressure.

22. An apparatus according to claim 21, wherein said pressure sensor has spaced first and second parts that are electrically conductive, and has a layer that is disposed between said first and second parts, that is made of a compressible material, and that is electrically insulating.

23. An apparatus according to claim 21, wherein said pressure sensor has an electrically conductive part, and has on at least one side of said electrically conductive part a layer that is made of a compressible material, and that is electrically insulating.

24. An apparatus according to claim 21, wherein said capacitance varies nonlinearly in response to applied pressure.

25. An apparatus according to claim 24, including circuitry that is electrically coupled to said pressure sensor, and that increases the nonlinearity with which said capacitance varies in response to applied pressure.

26. An apparatus according to claim 18, wherein said support member has first and second portions that extend approximately perpendicular to each other, said first portion being said flange, and said tag being supported on said second portion.

27. An apparatus according to claim 18, wherein said pressure sensor has a hole therethrough that is aligned with said hole through said flange.

28. An apparatus according to claim 27,
wherein said flange has a further hole therethrough, said holes through said flange being spaced from each other; and
wherein said pressure sensor has a further hole therethrough that is aligned with said further hole through said flange.

29. An apparatus according to claim 18, including a drum that has:
a body with a chamber therein, an exterior surface with an opening therein that communicates with said chamber, and a first portion with a hole therethrough;
a lid removably disposed adjacent said body so as to obstruct said opening, and having a second portion with a hole therethrough, said second portion being disposed adjacent said first portion, and said holes through said first and second portions being aligned; and
fastening structure for effecting a releasable coupling between said lid and said body, said fastening structure including a fastening part that extends through said hole in said flange, and through said aligned holes in said first and second portions.

30. An apparatus according to claim 29,
wherein said fastening part is a bolt having a head and a threaded shank, said shank extending through said holes in said flange and said first and second portions; and
wherein said fastening structure includes first and second nuts that threadedly engage said shank of said bolt, said first and second portions being disposed between said head and said first nut, and said flange being disposed between said first and second nuts.

31. A method of monitoring a drum having a body, a lid, and fastening structure for effecting a releasable coupling between said lid and said body, comprising:
monitoring with a pressure sensor a force produced by said fastening structure.

32. A method according to claim 31, including:
configuring said body of said drum to have a first portion;
configuring said lid to have a second portion disposed adjacent said first portion; configuring said fastening structure to be cooperable with said first and second portions; and
positioning said pressure sensor between said first and second portions.

33. A method according to claim 32, including:
configuring said fastening part to include a bolt having a head and threaded shank, and to include first and second nuts engaging said shank, said shank extending through said aligned holes in said flange and said first and second portions;
positioning said first and second portions between said head and said first nut; and
positioning said flange between said first and second nuts.

34. A method according to claim 31, including selecting a thin-film component to be said pressure sensor.

35. A method according to claim 31, including selecting as said pressure sensor a component having a resistance that varies as a function of pressure applied to said pressure sensor.

36. A method according to claim 31, including selecting as said pressure sensor a component having a capacitance that varies as a function of pressure applied to said pressure sensor.

37. A method according to claim 36,
wherein said capacitance of said pressure sensor varies nonlinearly in response to applied pressure; and
including electrically coupling said pressure sensor to circuitry that increases the nonlinearity with which said capacitance varies in response to applied pressure.

38. A method according to claim 31, including responding to detection by said pressure sensor of a change in said force by causing a tag supported on said drum to transmit a wireless signal.

39. A method according to claim 38, including configuring said body of said drum to have a recess in an exterior surface thereof; and supporting said tag within said recess.

40. A method according to claim 39, including configuring said tag to have an exterior surface that is flush with and conforms in shape to a shape of said exterior surface of said body.

41. A method according to claim 39, including providing within said recess a material that maintains said tag within said recess, and that has an exterior surface flush with and conforming in shape to a shape of said exterior surface of said body.
